(19) United States
(12) Patent Application Publication
(10) Pub. No.: US 2012/0163142 A1
(43) Pub. Date: Jun. 28, 2012

(54) Objective Lens Element and Optical Pickup Device Using the Same

(75) Inventors: Katsuhiko Hayashi, Nara (JP); Yasuhiro Tanaka, Hyogo (JP); Michihiro Yamagata, Osaka (JP)

(73) Assignee: Panasonic Corporation, Osaka (JP)

(21) Appl. No.: 13/411,655

(22) Filed: Mar. 5, 2012

Related U.S. Application Data
(63) Continuation of application No. PCT/JP2010/005695, filed on Sep. 17, 2010.

(30) Foreign Application Priority Data
Sep. 17, 2009 (JP) 2009-216229

(51) Int. Cl. G11B 7/00

(52) U.S. Cl. 369/44.32; 369/112.23; G9B/7

(57) ABSTRACT

An objective lens element which can obtain appropriate spot performance only by simple position adjustment, and an optical pickup device using the objective lens element are provided. In the objective lens element, an amount of a generated third-order astigmatism of a spot which is formed when symmetry axes of optically functional surfaces are located parallel to the normal line of a base plate and an incident light beam incident such that a central light beam thereof is tilted at 0.5 degree with respect to the normal line of the base plate is converged, is reduced to be less than an amount of a generated spherical aberration of a spot which is formed when the symmetry axes of the optically functional surface are located parallel to the normal line of the base plate and an incident light beam incident parallel to the normal line of the base plate is converged.

### CROSS-REFERENCE TO RELATED APPLICATION

This application is a U.S. continuation application filed under 35 USC 111(a) claiming benefit under 35 USC 120 and 365(c) of PCT application JP2010/005695, filed Sep. 17, 2010, which claims priority to Japanese Patent Application No. 2009-216229, filed on Sep. 17, 2009. The foregoing applications are hereby incorporated herein by reference.

### BACKGROUND OF THE INVENTION

1. Field of the Invention

The present invention relates to an objective lens element used for performing at least one of recording, reproducing, and erasing of information on an optical information storage medium, and an optical pickup device using the same.

2. Description of the Background Art

In recent years, optical information recording/reproducing apparatuses which perform high-density recording by using a blue laser beam have been commercially available. When an optical pickup device is configured to be compatible with a standard using a blue laser beam (e.g., BD), an older-generation standard using a red laser beam (e.g., DVD), and an older-generation standard using an infrared laser beam (e.g., CD), both an objective lens for blue laser beam and an objective lens for red laser beam and infrared laser beam (so-called DVD/CD compatible objective lens) are in general mounted on the apparatus.

However, when, during manufacturing of this dual-lens type optical pickup device, an actuator is adjusted such that a spot of one objective lens becomes appropriate, the spot performance of the other objective lens deteriorates. In addition, in order to appropriately adjust the spot performance of both objective lenses, the assembling steps and assembling time increase, leading to increase in manufacturing cost.

Japanese Patent No. 3235519 discloses technology in which a sine condition unsatisfied amount of one lens is previously set so as to be large at lens designing, to reduce an aberration which occurs when the lens is tilted with respect to the optical axis.

However, even when merely the performance of one objective lens is improved to reduce an aberration which occurs when the lens is tilted with respect to the optical axis, if off-axis light tilted with respect to the optical axis is incident on the lens, an aberration occurs, and appropriate spot performance cannot be obtained.

### SUMMARY OF THE INVENTION

It is an object of the present invention to provide an objective lens element which can obtain appropriate spot performance only by simple position adjustment, and an optical pickup device using the same.

The present invention is directed to an objective lens element which has optically functional surfaces on an incident side and an exit side and which converges an incident light beam through a base plate to form a spot. In the objective lens element, an amount of a generated third-order astigmatism of a spot which is formed when symmetry axes of the optically functional surfaces are located parallel to a normal line of the base plate and an incident light beam incident such that a central light beam thereof is tilted at 0.5 degree with respect to the normal line of the base plate is converged, is smaller than an amount of a generated spherical aberration of a spot which is formed when the symmetry axes of the optically functional surface are located parallel to the normal line of the base plate and an incident light beam incident parallel to the normal line of the base plate is converged.

Alternatively, instead of the above configuration, an amount of a generated third-order coma aberration of a spot which is formed when symmetry axes of the optically functional surfaces are located so as to be tilted at 0.5 degree with respect to a normal line of the base plate and an incident light beam incident parallel to the normal line of the base plate is converged, may not be larger than an amount of a generated third-order coma aberration of a spot which is formed when the symmetry axes of the optically functional surfaces are located parallel to the normal line of the base plate and an incident light beam incident such that a central light beam thereof is tilted at 0.5 degree with respect to the normal line of the base plate is converged.

An optical pickup device according to the present invention includes: a light source emitting a laser beam; either objective lens element described above, converging the laser beam emitted from the light source, on an information recording surface of an optical information storage medium to form a spot; an aberration compensation element disposed on an optical path between the light source and the objective lens element for compensating an aberration by moving along the optical path; and a detector detecting light reflected by the information recording surface.

According to the present invention, appropriate spot performance can be obtained only by simply adjusting the position of the objective lens element.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram of an objective lens element according to Embodiment 1;

FIG. 2 is a diagram illustrating a state where off-axis light is incident on the objective lens element according to Embodiment 1;

FIG. 3 is a diagram illustrating a state where the objective lens element according to this embodiment is tilted with respect to the normal line of a base plate of an optical disc;

FIG. 4 is a configuration diagram showing an optical pickup device according to Embodiment 2;

FIG. 5 is an optical path diagram of an objective lens element according to Numerical Example 1;

FIG. 6 is aberration diagrams showing a spherical aberration and an unsatisfied amount of a sine condition of the objective lens element according to Numerical Example 1;

FIG. 7 is a graph showing aberration components occurring when light tilted with respect to the optical axis is incident on the objective lens element according to Numerical Example 1;

FIG. 8 is a graph showing aberration components occurring when the optical axis of the objective lens element according to Numerical Example 1 is tilted with respect to the normal line of a base plate of an optical disc;

FIG. 9 is an optical path diagram of an objective lens element according to Numerical Example 2;

FIG. 10 is aberration diagrams showing a spherical aberration and an unsatisfied amount of a sine condition of the objective lens element according to Numerical Example 2;

FIG. 11 is a graph showing aberration components occurring when light tilted with respect to the optical axis is incident on the objective lens element according to Numerical Example 2, namely, when off-axis light is incident thereon; and

FIG. 12 is a graph showing aberration components occurring when the optical axis of the objective lens element according to Numerical Example 2 is tilted with respect to the normal line of a base plate of an optical disc.

### DESCRIPTION OF THE PREFERRED EMBODIMENTS

### Embodiment 1

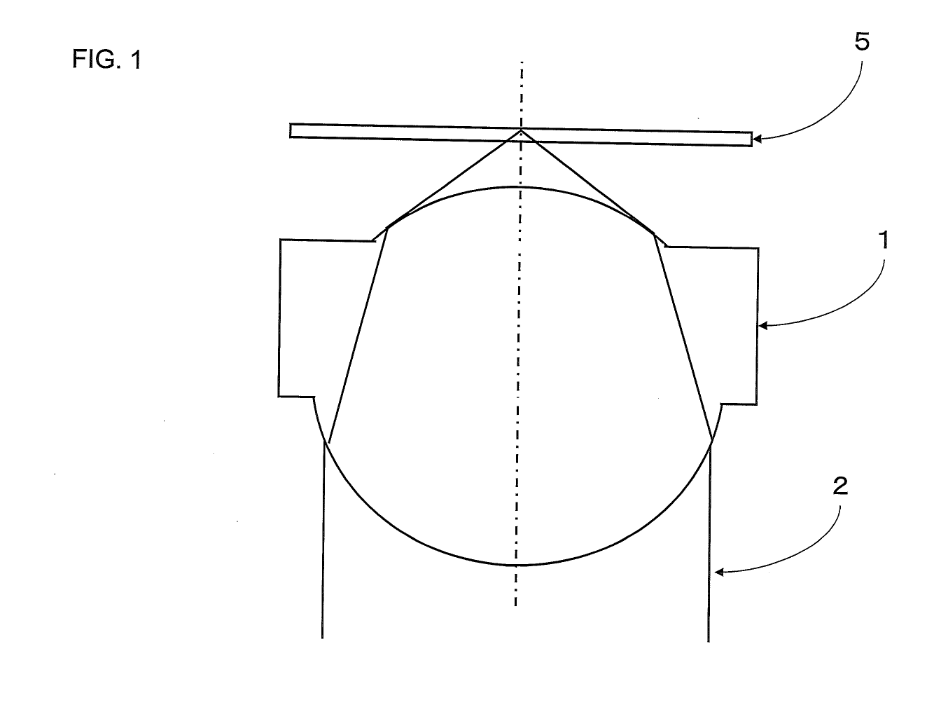

FIG. 1 is a configuration diagram of an objective lens element according to Embodiment 1.

The objective lens element 1 according to the present embodiment is an objective lens element dedicated for BD. Specifically, the objective lens element 1 has an NA of 0.85, and converges light of a wavelength of 408 nm through a protective base plate having a thickness of 0.1 mm to form, on an information recording surface of an optical disc, a spot which is favorably aberration-compensated. However, in order to enable compatibility with a two-layer BD disc is achieved, 87.5 μm which is a value intermediate between the thickest protective base plate thickness and the thinnest protective base plate thickness is used as a protective base plate thickness at designing. In addition, in order to enable compatibility with a multilayer BD disc having three or more layers is achieved, the protective base plate thickness at designing is appropriately adjusted.

Further, when an optical pickup device is configured by using the objective lens element 1 according to the present embodiment, a collimating lens is inserted on an optical path between a light source and the objective lens element 1. The collimating lens moves along the optical axis direction and serves as an aberration compensation element which compensates a spherical aberration.

As shown in FIG. 1, during recording or reproducing on a BD disc 5, a light beam 2 which has been emitted from the light source and has passed through the collimating lens is incident as converging light on a first surface of the objective lens element 1. The first surface of the objective lens element 1 is an aspheric surface.

The light beam incident on the objective lens element 1 is emitted from a second surface. The second surface is an aspheric surface. Next, the light beam having passed through the second surface of the objective lens element 1 is converged on an information recording surface of the BD disc 5 to form a spot. The light beam 2 reflected by the information recording surface passes through the objective lens element 1 again and is converted by a relay lens (not shown) on a detector.

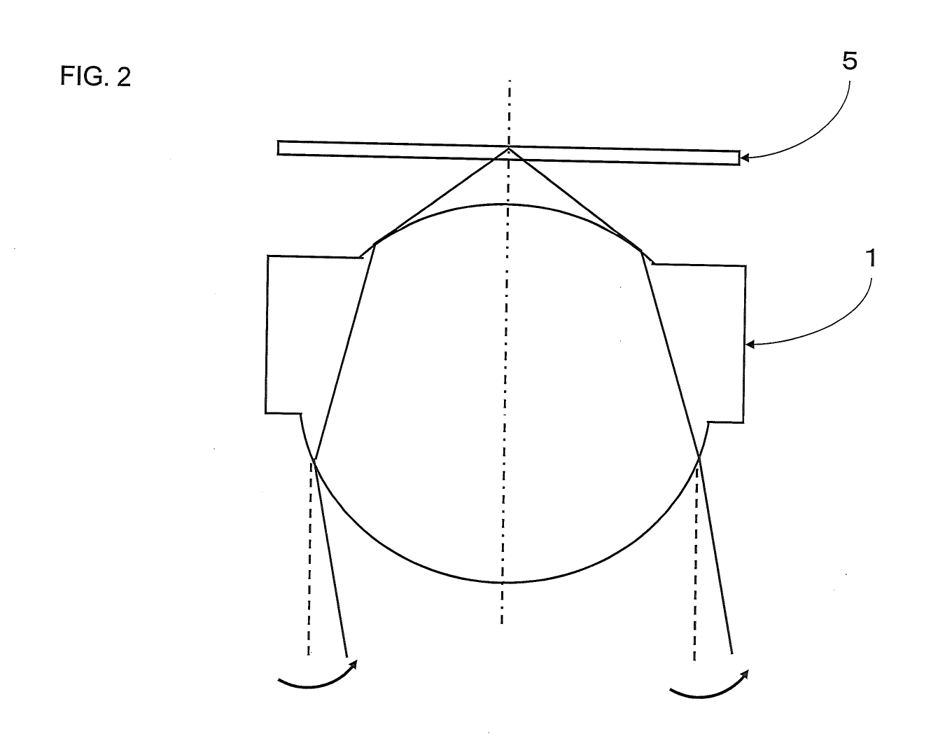

FIG. 2 is a diagram illustrating a state where off-axis light is incident on the objective lens element according to Embodiment 1.

In the optical pickup device, off-axis light may be incident on the objective lens element due to a shift of the objective lens element at tracking, a mounting error of the light source, an arrangement error of an optical system, or the like. Thus, the objective lens element according to the present embodiment is designed such that an amount of a third-order astigmatism occurring in the following state (1) is smaller than an amount of a third-order spherical aberration occurring in the following state (2).

(1) State where the symmetry axes of the optically functional surfaces (the optical axis) are located parallel to the normal line of a base plate of the optical disc 5 and an incident light beam (a solid line in FIG. 2) incident such that the central light beam thereof is tilted with respect to the normal line of the base plate is converged to form a spot.

(2) State where the symmetry axes of the optically functional surfaces are located parallel to the normal line of the base plate of the optical disc 5 and an incident light beam (a broken line in FIG. 2) incident parallel to the normal line of the base plate is converged to form a spot.

Here, an amount of a generated third-order astigmatism of a spot which is formed when the symmetry axes of the optically functional surfaces are located parallel to the normal line of the base plate of the optical disc 5 and an incident light beam incident such that the central light beam thereof is tilted at 0.5 degree with respect to the normal line of the base plate is converged, is preferably smaller than ⅔ of and more preferably smaller than ½ of an amount of a generated third-order spherical aberration of a spot which is formed when the symmetry axes of the optically functional surfaces are located parallel to the normal line of the base plate of the optical disc 5 and an incident light beam incident parallel to the normal line of the base plate is converged.

When such designing is performed, an astigmatism which cannot be compensated can be reduced, and a spherical aberration caused by tilt of an incident light beam can be compensated by the aberration compensation element. Thus, even when off-axis light is incident on the objective lens element, a spot formed on the information recording surface is maintained at a desired level.

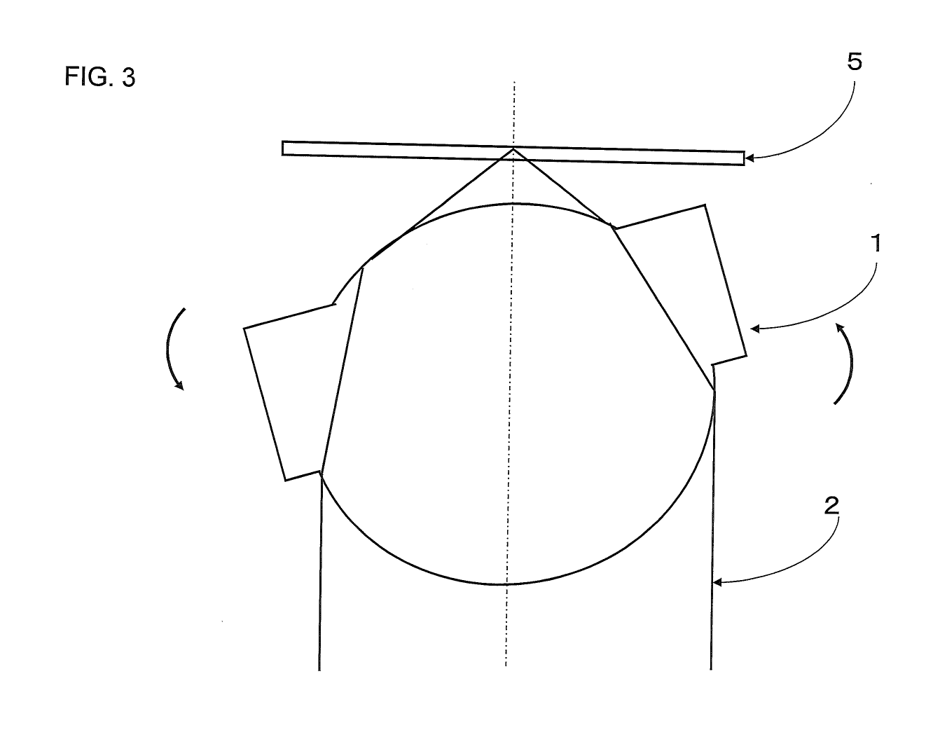

FIG. 3 is a diagram showing a state where the objective lens element according to Embodiment 1 is tilted with respect to the normal line of the base plate of the optical disc.

In the optical pickup device, during assembling, the objective lens element may be disposed at a tilt in order to appropriately compensate an aberration of the entire optical system. In addition, in order to compensate an aberration caused by unevenness of the thickness of the base plate due to a manufacturing error of the optical disc, by tilt of the optical disc, or by tilt of the optical disc due to its rotation, an actuator on which the objective lens element is mounted may be tilted and used. Thus, the objective lens element according to the present embodiment is designed such that an amount of a third-order coma aberration occurring in the following state (3) is not larger than an amount of a third-order coma aberration occurring in the following state (4).

(3) State where the symmetry axes of the optically functional surfaces are located so as to be tilted with respect to the normal line of the base plate and an incident light beam incident parallel to the normal line of the base plate is converged to form a spot.

(4) State where the symmetry axes of the optically functional surfaces (the optical axis) are located parallel to the normal line of the base plate of the optical disc 5 and an incident light beam incident such that the central light beam thereof is tilted with respect to the normal line of the base plate is converged to form a spot.

Here, a third-order coma aberration of a spot which is formed when the symmetry axes of the optically functional surfaces (the optical axis) are located so as to be tilted at 0.5 degree with respect to the normal line of the base plate and an incident light beam incident parallel to the normal line of the base plate is converged, is preferably equal to or less than 25 mλ and more preferably equal to or less than 15 mλ.

When a third-order coma aberration of a spot which is formed when the symmetry axes of the optically functional surfaces (the optical axis) are located so as to be tilted at 0.5 degree with respect to the normal line of the base plate and an incident light beam incident parallel to the normal line of the base plate is converged, is equal to or less than 25 mλ, a third-order coma aberration of a spot which is formed when the symmetry axes of the optically functional surfaces are located parallel to the normal line of the base plate of the optical disc 5 and an incident light beam incident such that the central light beam thereof is tilted at 0.5 degree with respect to the normal line of the base plate is converged, is preferably equal to or more than 25 mλ.

When a third-order coma aberration of a spot which is formed when the symmetry axes of the optically functional surfaces (the optical axis) are located so as to be tilted at 0.5 degree with respect to the normal line of the base plate and an incident light beam incident parallel to the normal line of the base plate is converged, is equal to or less than 15 mλ, a third-order coma aberration of a spot which is formed when the symmetry axes of the optically functional surfaces are located parallel to the normal line of the base plate of the optical disc 5 and an incident light beam incident such that the central light beam thereof is tilted at 0.5 degree with respect to the normal line of the base plate is converged, is preferably equal to or more than 35 mλ.

When such designing is performed, an amount of a coma aberration occurring when the objective lens element is tilted with respect to the normal line of the base plate of the optical disc is smaller than an amount of a coma aberration occurring due to off-axis light. Thus, during assembling of an optical pickup device in which two objective lens elements are mounted on one actuator, adjustment of the actuator is made easy and manufacturing of the optical pickup device is made easy. Hereinafter, this point will be more specifically described.

A case is assumed where, together with the objective lens element dedicated for BD according to the present invention, a DVD/CD compatible objective lens element is mounted on the same actuator. For example, initially, the tilt of the actuator on which the two objective lens elements are mounted is adjusted such that spot performance for DVD and CD becomes appropriate. In this case, the spot performance of the objective lens element dedicated for BD which is mounted on the same actuator is not necessarily appropriate. As one of the reasons, it is thought that the objective lens element dedicated for BD is tilted with respect to the optical axis and thus a coma aberration occurs. In general, lens designing is performed such that a sine condition is satisfied and no coma aberration is caused to off-axis light. When such designing is performed, a coma aberration occurring when the objective lens element is tilted with respect to the optical axis is great. By independently adjusting only the tilt of the objective lens element dedicated for BD, it is possible to improve the spot performance. However, such adjustment is difficult in reality, since an amount of a coma aberration generated in response to the angle of tilt of the objective lens element is very large.

As described above, the objective lens element 1 according to the present invention is designed such that an amount of a coma aberration occurring when the optical axis thereof is tilted with respect to the normal line of the base plate of the optical disc 5 is reduced. In other words, the objective lens element 1 has low aberration sensitivity with respect to tilt, and thus the spot performance thereof does not deteriorate even when being tilted to some extent. Thus, even when the angle of the actuator is adjusted such that “the spot performance of the DVD/CD compatible objective lens element becomes appropriate”, the spot performance of the objective lens element 1 dedicated for BD does not greatly deteriorate from appropriate performance.

Moreover, in addition to a coma aberration occurring due to the optical axis of the objective lens element being tilted with respect to the normal line of the base plate of the optical disc 5, a coma aberration caused by an assembling error of the entire optical system or a coma aberration possessed by each optical element may remain. In this case as well, in the objective lens element of the present invention, it is possible to cancel the coma aberration of the entire optical system by slight position adjustment of the light source, since an amount of a coma aberration occurring when off-axis light is incident is large. In the case of a conventional general objective lens element which satisfies a sine condition, an amount of a coma aberration occurring when off-axis light is incident is small, and thus it is difficult to cancel a coma aberration by such adjustment.

When the objective lens element 1 according to the present invention is used, it is possible to assemble the optical pickup device such that convergence spots of all wavelengths become appropriate, by such a simple adjustment method. Here, the type of the optical disc 5 is not particularly limited to a specific one. The optical disc 5 may be, for example, CD (Compact Disc), CD-R (Compact Disc Recordable), CD-RW (Compact Disc ReWritable), CD-ROM (Compact Disc Read Only Memory), DVD (Digital Versatile Disc), DVD-R (Digital Versatile Disc Recordable), DVD-RW (Digital Versatile Disc ReWritable), DVD-ROM (Digital Versatile Disc Read Only Memory), DVD-RAM (Digital Versatile Disc Random Access Memory), EVD (Enhanced Versatile Disc), EVD-R (Enhanced Versatile Disc Recordable), EVD-RW (Enhanced Versatile Disc ReWritable), EVD-ROM (Enhanced Versatile Disc Read Only Memory), EVD-RAM (Enhanced Versatile Disc Random Access Memory), BD (Blu-ray Disc), BD-R (Blu-ray Disc Recordable), BD-RW (Blu-ray Disc ReWritable), BD-ROM (Blu-ray Disc Read Only Memory), or BD-RAM (Blu-ray Disc Random Access Memory), all of which are registered trademarks.

In the present embodiment, the optical pickup device in which the two objective lens elements are mounted on the same actuator has been described, but the design of the present invention is also applicable to an optical pickup device on which only one objective lens element is mounted. In this case as well, when designing is performed such that the optical characteristics described in the present embodiment are obtained, simple assembling of an optical pickup device can be similarly realized.

### Embodiment 2

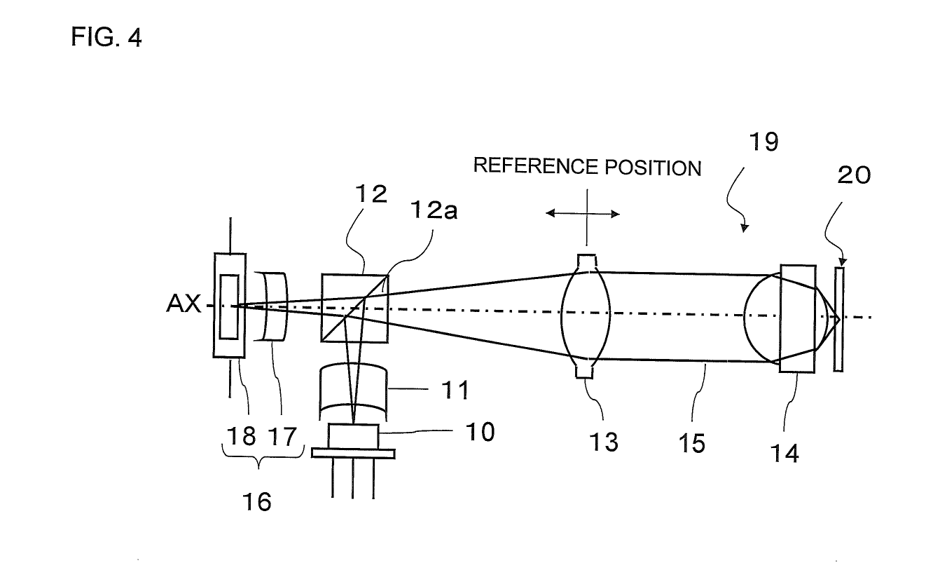

FIG. 4 is a configuration diagram showing an optical pickup device according to Embodiment 2.

The optical pickup device shown in FIG. 4 includes a light source 10 which emits light of a predetermined wavelength, a beam shaping lens 11, a polarizing beam splitter 12, a collimating lens 13, an objective lens element 14, a detection lens 17, and a detector 18. The objective lens element 14 is the objective lens element dedicated for BD which is described in Embodiment 1. As an example, the wavelength of the light source 10 is 390 to 450 nm, the NA of the objective lens element 14 is equal to or higher than 0.8, and the distance between the objective lens element 14 and a BD disc 20 (the working distance) is less than 100 μm.

The collimating lens 13 is moveable along the optical axis direction. By movement of the collimating lens 13 along the optical axis direction, the parallelism of an incident light beam is changed to compensate a generated spherical aberration of a convergence spot. Here, the generated spherical aberration refers to a spherical aberration occurring due to wavelength change, temperature change, change in thickness from a surface of a disc to a recording layer, a manufacturing error of the optical element, or an assembling error of the pickup device.

In FIG. 4, only an optical system for BD is shown, but an optical system for DVD or CD may be provided together. On an actuator on which the objective lens element 14 for BD is mounted, an objective lens element dedicated for DVD, an objective lens element dedicated for CD, an objective lens element for DVD/CD compatibility, or another objective lens element may be mounted.

The first surface of the objective lens element 14 is an aspheric surface. In the present embodiment, the aspheric surface of the first surface is represented by one aspheric surface formula, but may be divided into a plurality of concentric regions. In addition, a diffraction structure may be provided on the optically functional surface.

As shown in FIG. 4, a light beam 15 emitted from the light source 10 is shaped by the beam shaping lens 11 into an elliptic beam, then is reflected by a reflecting surface 12a of the polarizing beam splitter 12, passes through the collimating lens 13, and is incident as substantially parallel light on the first surface of the objective lens element 14.

The light beam 15 is emitted from the second surface of the objective lens element 14 and favorably converged on an information recording surface of the BD disc 20. Then, the light beam 15 reflected by the information recording surface passes through the objective lens element 14 again, passes through the collimating lens 13 and the polarizing beam splitter 12, and is converged by the detection lens 17 on the detector 18.

As described above, the collimating lens 13 is moveable along the optical axis direction, in order to compensate a spherical aberration occurring during recording or reproducing on the BD disc 20. Instead of the collimating lens 13, another optical element such as a liquid crystal element, a beam expander, and a liquid lens can be used as an aberration compensation element as long as it can compensate a spherical aberration. In addition, the beam shaping lens 11 may be omitted, but it is preferred that the beam shaping lens 11 is provided, since the light use efficiency can be improved.

In the objective lens element 14, an amount of a third-order astigmatism occurring due to off-axis incidence is reduced to be less than an amount of a third-order spherical aberration. There is no method for compensating a third-order astigmatism in an optical pickup device, and thus it is preferred that a generated aberration is reduced as much as possible. Meanwhile, it is possible to compensate a third-order spherical aberration by an aberration compensation element (e.g., the collimating lens 13), and thus no problem arises even when a third-order spherical aberration occurs. Therefore, in the optical pickup device according to the present embodiment, a favorable spot can be formed on an information recording surface of an information storage medium, and stable recording and reproducing are enabled.

Further, according to the optical pickup device of the present invention, appropriate spot performance can be obtained only by performing simple adjustment during assembling. In particular, in the objective lens element 14 according to the present invention, since an amount of a coma aberration occurring due to off-axis light is not larger than an amount of a coma aberration occurring when the lens is tilted with respect to the optical axis, adjustment is easy and assembling can be simply performed even when two objective lens elements are included.

In the present embodiment, designing is performed such that a third-order coma aberration occurring when the objective lens element for BD is tilted with respect to the optical axis is reduced. However, the present invention may not be limited thereto. Another objective lens element may be similarly designed.

### EXAMPLES

Numerical Examples of the present invention will be specifically described with construction data, aberration diagrams, and the like. Numerical Examples 1 and 2 correspond to Embodiments 1 and 2 described above, respectively.

In each Numerical Example, a surface to which an aspheric coefficient is provided indicates a refractive optical surface having an aspherical shape or a surface having a refraction function equal to that of an aspheric surface. The surface shape of an aspheric surface is defined by the following formula 1.

$$X = \frac{{C}_{j} {h}^{2}}{1 + \sqrt{1 - ( 1 + {k}_{j} ) {C}_{j}^{2} {h}^{2}}} + \sum {A}_{j , n} {h}^{n} .$$

### Here,

X is the distance from an on-the-aspheric-surface point at a height h relative to the optical axis to a tangential plane at the top of the aspheric surface,

h is the height relative to the optical axis,

Cⱼ is the radius of curvature at the top of an aspheric surface of a lens jth surface (Cⱼ=1/Rⱼ),

Kⱼ is the conic constant of the lens jth surface, and

A_{j,n} is the nth-order aspheric constant of the lens jth surface.

### Numerical Example 1

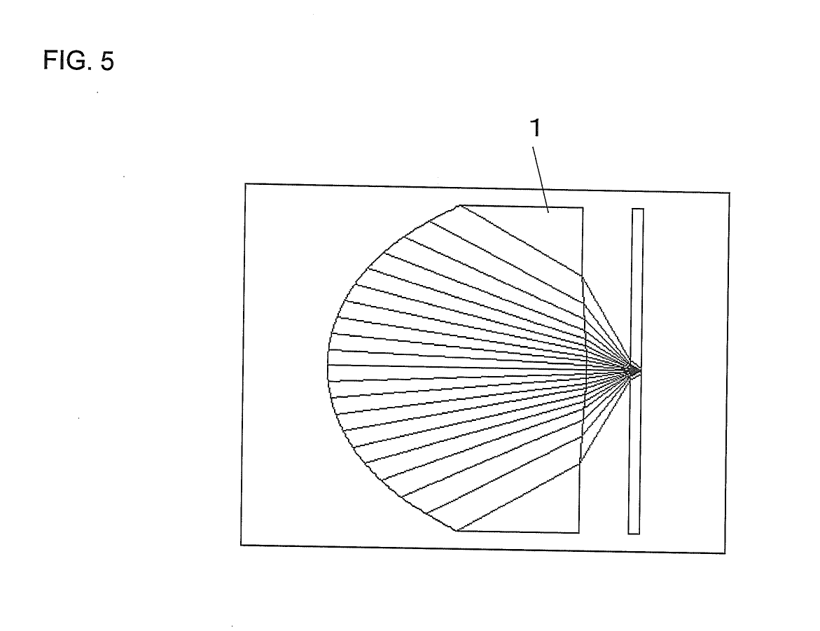

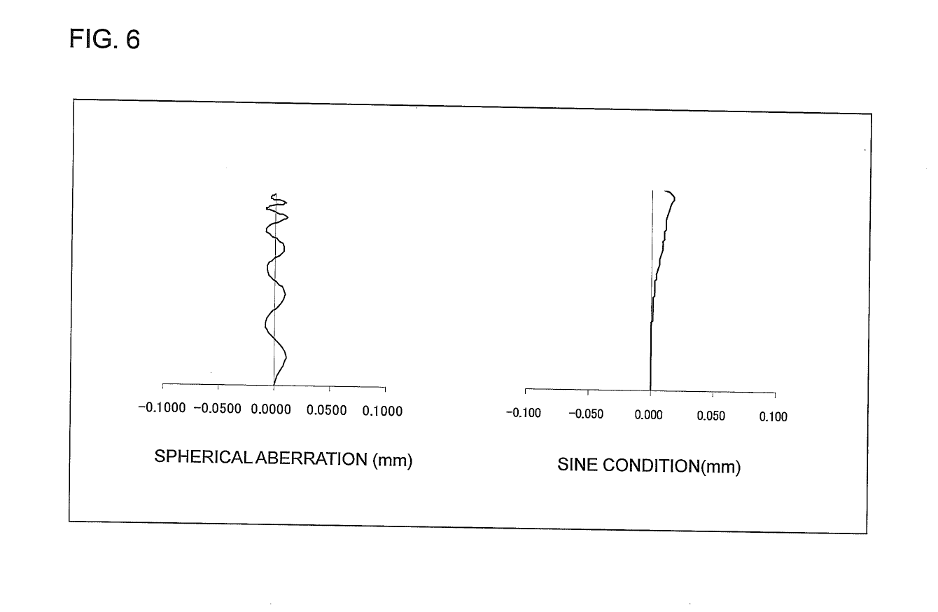

Table 1 to 4 show construction data of Numerical Example 1. As shown in Tables 1 to 4, the designed wavelength is 408 nm, the disc base material thickness (designed central base material thickness is 0.0725 mm, the focal distance is 1.3 mm, the effective diameter is φ2.18 mm, the NA is 0.86, and the lens thickness is 1.73 mm. The effective diameter is the value of a first surface (surface number 1 in Table 2) of the objective lens element. FIG. 5 is an optical path diagram of the objective lens element according to Numerical Example 1. FIG. 6 is aberration diagrams showing a spherical aberration and an unsatisfied amount of a sine condition of the objective lens element according to Numerical Example 1.

TABLE 1

| | |
|---|---|
| Wavelength | 0.408 |
| Effective diameter | 2.1844 |
| NA | 0.86 |
| Working distance (WD) | 0.3 |
| Disc thickness (DT) | 0.0725 |
| Focal length | 1.3 |

TABLE 2

| Surface | Radius of curvature at | | | |
|---|---|---|---|---|
| No. | the top of lens surface | Thickness | Material | Remarks |
| 0 | ∞ | ∞ | Air | |
| 1 | 0.8931618 | 1.732514 | n1 | Aspherical |
| 2 | −1.518585 | WD | Air | Aspherical |
| 3 | ∞ | DT | Disc | Planar |
| 4 | ∞ | | | Planar |

TABLE 3

| | |
|---|---|
| Wavelength | 408 |
| n1 | 1.60794995 |
| Disc | 1.61641628 |

TABLE 4

| | Aspherical constants |
|---|---|
| First surface | Aspherical surface |
| RD | 0.8931618 |
| k | −0.3867106 |
| A2 | 0.00000000 |
| A4 | −0.027682236 |
| A6 | 0.16941141 |
| A8 | −0.8417142 |
| A10 | 2.0884695 |
| A12 | −2.9343486 |
| A14 | 2.1340771 |
| A16 | −0.64131772 |
| | Aspherical constants |
| Second surface | Aspherical surface |
| RD | −1.518585 |
| k | 0.00000000 |
| A2 | 0.00000000 |
| A4 | 3.0257009 |
| A6 | −26.825567 |
| A8 | 183.33578 |
| A10 | −812.77067 |
| A12 | 2137.1993 |
| A14 | −3029.3497 |
| A16 | 1786.4563 |

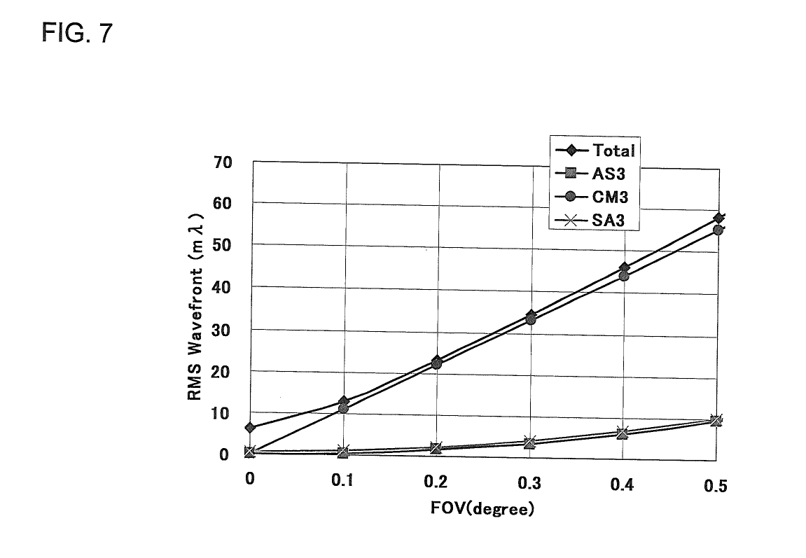

FIG. 7 is a graph showing aberration components occurring when light tilted with respect to the optical axis is incident on the objective lens element according to Numerical Example 1, namely, when off-axis light is incident thereon. The horizontal axis indicates a view angle of a light beam, and the vertical axis indicates an aberration amount. From FIG. 7, when the tilt of the off-axis light is 0.5 degree, the generated third-order astigmatism is 9 mλ, the generated coma aberration is 55 mλ, and the generated spherical aberration is 10 mλ.

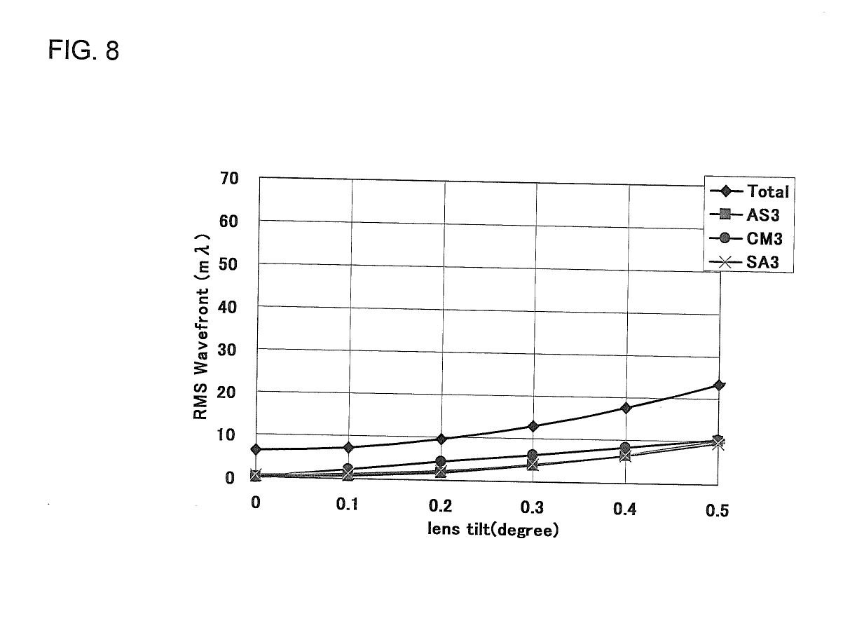

FIG. 8 is a graph showing aberration components occurring when the optical axis of the objective lens element according to Numerical Example 1 is tilted with respect to the normal line of a base plate of an optical disc. The horizontal axis indicates an angle of tilt of the optical axis with respect to the normal line of the base plate of the optical disc, and the vertical axis indicates an aberration amount. From FIG. 8, when the lens tilt angle is 0.5 degree, the generated third-order coma aberration is 10 mλ.

### Numerical Example 2

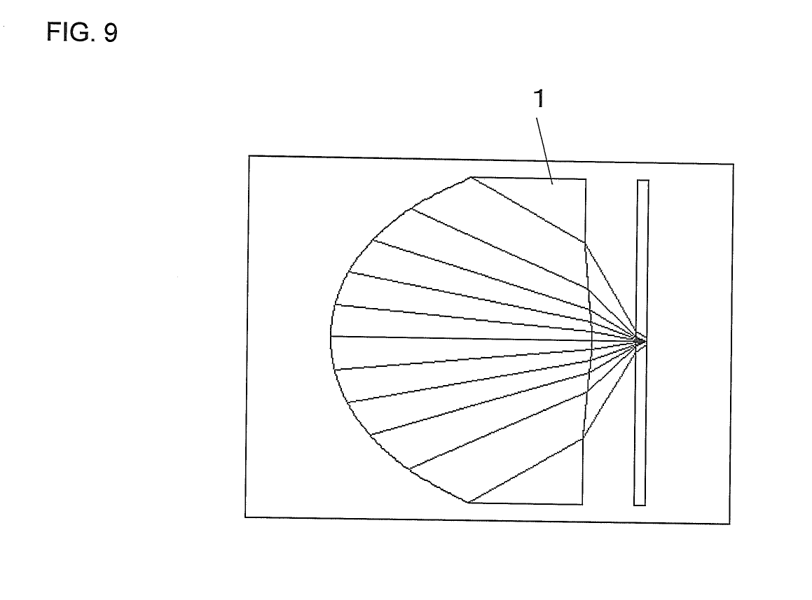

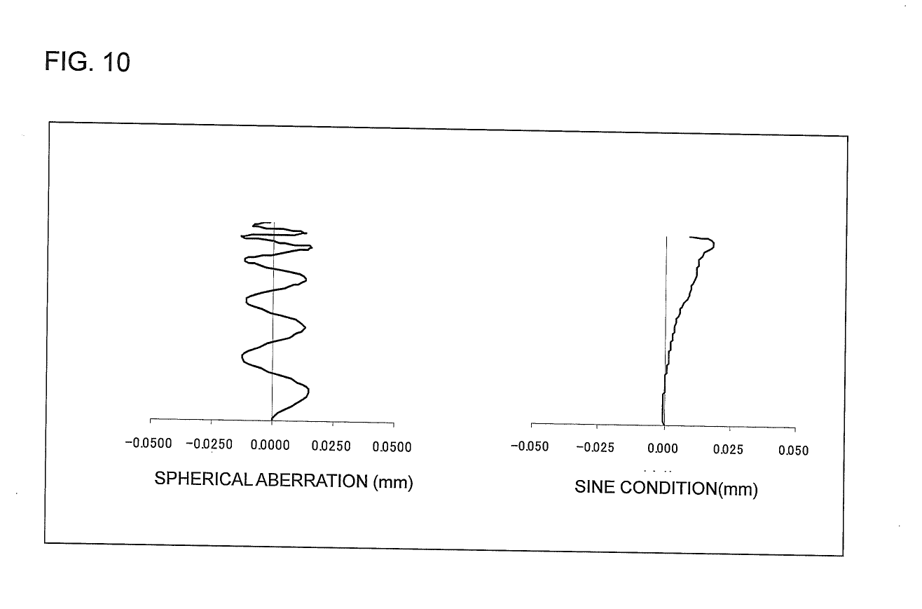

Tables 5 to 8 show construction data of Numerical Example 2. As shown in Table 5, the designed wavelength is 408 nm, the disc base material thickness (designed central base material thickness is 0.0725 mm, the focal distance is 1.3 mm, the effective diameter is φ2.18 mm, the NA is 0.86, and the lens thickness is 1.74 mm. The effective diameter is the value of a first surface (surface number 1 in Table 6) of the objective lens element. FIG. 9 is an optical path diagram of the objective lens element according to Numerical Example 2. FIG. 10 is aberration diagrams showing a spherical aberration and an unsatisfied amount of a sine condition of the objective lens element according to Numerical Example 2.

TABLE 5

| | |
|---|---|
| Wavelength | 0.408 |
| Effective diameter | 2.1844 |
| NA | 0.86 |
| Working distance (WD) | 0.3 |
| Disc thickness (DT) | 0.0725 |
| Focal length | 1.3 |

TABLE 6

| Surface | Radius of curvature at | | | |
|---|---|---|---|---|
| No. | the top of lens surface | Thickness | Material | Remarks |
| 0 | ∞ | ∞ | Air | |
| 1 | 0.8594265 | 1.743466 | n1 | Aspherical |
| 2 | −1.178821 | WD | Air | Aspherical |
| 3 | ∞ | DT | Disc | Planar |
| 4 | ∞ | | | Planar |

TABLE 7

| | |
|---|---|
| Wavelength | 408 |
| n1 | 1.56673301 |
| Disc | 1.61641628 |

TABLE 8

| | Aspherical constants |
|---|---|
| First surface | Aspherical surface |
| RD | 0.8594265 |
| k | −0.4269598 |
| A2 | 0.00000000 |
| A4 | −0.03515034 |
| A6 | 0.26157241 |
| A8 | −1.2473825 |
| A10 | 3.0803258 |
| A12 | −4.254726 |
| A14 | 3.0391694 |
| A16 | −0.89165434 |
| | Aspherical constants |
| Second surface | Aspherical surface |
| RD | −1.178821 |
| k | 0.00000000 |
| A2 | 0.00000000 |
| A4 | 3.5786243 |
| A6 | −28.551533 |
| A8 | 175.43306 |
| A10 | −700.26975 |
| A12 | 1668.8723 |
| A14 | −2153.6776 |
| A16 | 1159.2497 |

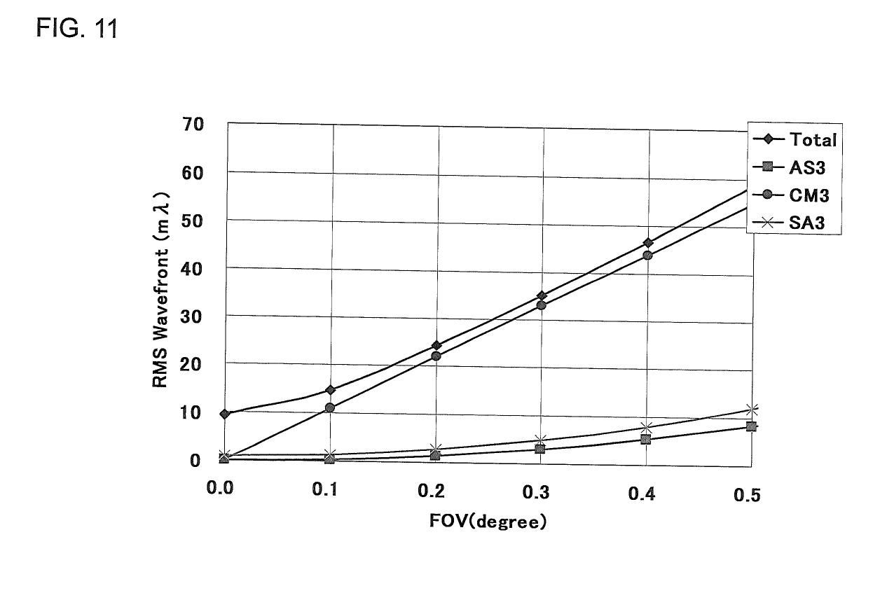

FIG. 11 is a graph showing aberration components occurring when light tilted with respect to the optical axis is incident on the objective lens element according to Numerical Example 2, namely, when off-axis light is incident thereon. The horizontal axis indicates a view angle of a light beam, and the vertical axis indicates an aberration amount. From FIG. 11, when the tilt of the off-axis light is 0.5 degree, the generated third-order astigmatism is 8 mλ, the generated third-order coma aberration is 55 mλ and the generated third-order spherical aberration is 12 mλ.

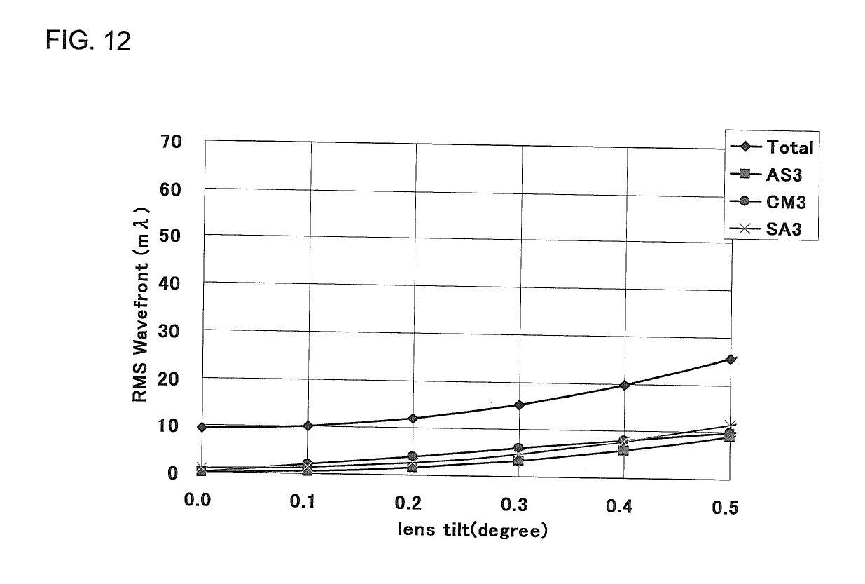

FIG. 12 is a graph showing aberration components occurring when the optical axis of the objective lens element according to Numerical Example 2 is tilted with respect to the normal line of a base plate of an optical disc. The horizontal axis indicates an angle of tilt of the optical axis with respect to the normal line of the base plate of the optical disc, and the vertical axis indicates an aberration amount. From FIG. 12, when the lens tilt angle is 0.5 degree, the generated third-order coma aberration is 10 mλ.

The present invention can be used for an objective lens element used for performing recording, reproducing, or erasing of information on an optical disc, an optical pickup device using the objective lens, and an information apparatus such as a personal computer, a video apparatus such as an optical disc recorder, an audio apparatus, and the like, which have the optical pickup device incorporated therein.

While the invention has been described in detail, the foregoing description is in all aspects illustrative and not restrictive. It will be understood that numerous other modifications and variations can be devised without departing from the scope of the invention.

What is claimed is:

1. An objective lens element which has optically functional surfaces on an incident side and an exit side and which converges an incident light beam through a base plate to form a spot, wherein
an amount of a generated third-order astigmatism of a spot which is formed when symmetry axes of the optically functional surfaces are located parallel to a normal line of the base plate and an incident light beam incident such that a central light beam thereof is tilted at 0.5 degree with respect to the normal line of the base plate is converged, is smaller than an amount of a generated spherical aberration of a spot which is formed when the symmetry axes of the optically functional surface are located parallel to the normal line of the base plate and an incident light beam incident parallel to the normal line of the base plate is converged.

2. An objective lens element which has optically functional surfaces on an incident side and an exit side and which converges an incident light beam through a base plate to form a spot, wherein
an amount of a generated third-order coma aberration of a spot which is formed when symmetry axes of the optically functional surfaces are located so as to be tilted at 0.5 degree with respect to a normal line of the base plate and an incident light beam incident parallel to the normal line of the base plate is converged, is not larger than an amount of a generated third-order coma aberration of a spot which is formed when the symmetry axes of the optically functional surfaces are located parallel to the normal line of the base plate and an incident light beam incident such that a central light beam thereof is tilted at 0.5 degree with respect to the normal line of the base plate is converged.

3. An optical pickup device comprising:
a light source emitting a laser beam;
an objective lens element according to claim 1, converging the laser beam emitted from the light source, on an information recording surface of an optical information storage medium to form a spot;
an aberration compensation element disposed on an optical path between the light source and the objective lens element for compensating an aberration by moving along the optical path; and
a detector detecting light reflected by the information recording surface.

4. An optical pickup device comprising:
a light source emitting a laser beam;
objective lens element according to claim 2, converging the laser beam emitted from the light source, on an information recording surface of an optical information storage medium to form a spot;
an aberration compensation element disposed on an optical path between the light source and the objective lens element for compensating an aberration by moving along the optical path; and
a detector detecting light reflected by the information recording surface.
